(19) United States
(12) Patent Application Publication
(10) Pub. No.: US 2022/0101311 A1
(43) Pub. Date: Mar. 31, 2022

(54) SYSTEMS AND METHODS FOR TRACKING THE EXCHANGE OF PHYSICAL CURRENCY BETWEEN ENTITIES

(71) Applicant: Mastercard International Incorporated, Purchase, NY (US)

(72) Inventors: Shawn Mehrhoff, Saint Ann, MO (US); Matthew Wease, O'Fallon, MO (US); Christopher T. Scholl, Saint Peter's, MO (US)

(21) Appl. No.: 17/034,501

(22) Filed: Sep. 28, 2020

(51) Int. Cl. G06Q 20/38

(52) U.S. Cl. CPC G06Q 20/389

(57) ABSTRACT

Described are systems and methods for tracking a physical currency. A computing device includes a memory device for storing data and a processor in communication with the memory device. The processor is configured to store a plurality of currency identifiers associated with a respective plurality of physical currency units and store a plurality of entity identifiers associated with a respective plurality of an individual currency accounts. The processor is further configured to create and store a first electronic record including a first currency identifier and a first entity identifier. The record indicates that a first entity is a registered owner of a first physical currency unit. The processor is further configured to create and store a second record, in response to a transfer of the first currency unit to a second entity. The second record indicates that the second entity is a registered owner of a first physical currency unit.

### BACKGROUND

The field of the present disclosure relates generally to tracking the exchange of a physical currency unit transferred between entities, and more particularly, to systems and methods for maintaining transfer histories for physical currency units, each transfer history including one or more currency transfer records that track the transfer of the physical currency unit between entities.

Cash is still used throughout the world to make purchases. Physical bills of various values and/or currencies can be used in different parts of the world to make purchases. For example, a first entity, such as an individual person and/or a merchant, may wish to pay a second entity using a physical currency unit, such as a paper bill of a currency (e.g., cash). Unfortunately, after the first entity pays the second entity with the physical currency unit, there may be limited proof and/or record of the actual transfer of the physical currency unit. In other words, once the first entity has handed over the physical currency unit to the second entity, the first entity may have no proof that they paid the second entity and that the second entity accepted the payment. In addition, the second entity has no assurance, when accepting the physical currency unit, that the first entity acquired the currency by legitimate means.

In some parts of the world, a person may withdraw large sums of cash from a bank or financial institution on behalf of multiple other persons, with the understanding that the first person will properly distribute the withdrawn cash to the other persons. A second person may authorize the first person to make a physical currency withdrawal from the second person's bank account on behalf of the second person (e.g., a cash withdrawal from an ATM or bank). For example, a first person such as a caregiver may run errands for a second person, including withdrawing cash from the second person's bank account at the request of the second person. Once the physical currency unit has been withdrawn, there may be limited proof that the all of the withdrawn cash has been transferred to the second person and that the second person accepted the cash. In some cases, the second person may wish to track the physical currency to ensure that they receive the entirety of the cash that was withdrawn. Further, the first person (the caregiver) may also want to confirm and record that the cash was accepted by the second person and is no longer in in the caregiver's possession.

Accordingly, it may be advantageous to have systems and methods which track the transfer of a physical currency unit between entities.

### BRIEF DESCRIPTION

In one aspect, a computing device for tracking a physical currency unit is provided. The computing device includes a processor communicatively coupled to a memory. The processor is programmed to store a plurality of currency identifiers in the memory. The plurality of currency identifiers are associated with a respective plurality of physical currency units. Each currency identifier uniquely identifies the respective physical currency unit. The processor is programmed to store a plurality of entity identifiers in the memory. The plurality of entity identifiers are associated with a respective plurality of individual currency accounts associated with a respective plurality of entities. Each entity identifier uniquely identifies the respective entity and the respective individual currency account. The processor is also programmed to create a first electronic record including a first currency identifier of the plurality of currency identifiers and a first entity identifier of the plurality of entity identifiers. The first record indicates that a first entity of the plurality of entities, as identified by the first entity identifier, is a registered owner of first physical currency unit, as identified by the first currency identifier. The processor is further programmed store the first record in a tracking database. The processor is programmed to create a second record, in response to a transfer of the first currency unit to a second entity. The second record includes the first currency identifier and a second entity identifier of the second entity and indicates the second entity is the registered owner of the first currency unit, as identified by the first currency identifier. The processor is programmed to store the second record in the tracking database. The second record is associated with the first record based on the first currency identifier, to track the transfer of the first currency unit represented by the first currency identifier between the first entity and the second entity.

In another aspect, a computer-implemented method for tracking a physical currency unit is provided. The method is implemented using a computing device including a processor in communication with at least one memory device for storing data. The method includes storing a plurality of currency identifiers in the memory. The plurality of currency identifiers are associated with a respective plurality of physical currency units. Each currency identifier uniquely identifies the respective physical currency unit. The method further includes storing a plurality of entity identifiers in the memory. The plurality of entity identifiers are associated with a respective plurality of individual currency accounts associated with a respective plurality of entities. Each entity identifier uniquely identifies the respective entity and the respective individual currency account. The method further includes creating a first electronic record including a first currency identifier of the plurality of currency identifiers and a first entity identifier of the plurality of entity identifiers. The first record indicates that a first entity of the plurality of entities, as identified by the first entity identifier, is a registered owner of first physical currency unit, as identified by the first currency identifier. The method further includes storing the first record in a tracking database. The method also includes creating a second record, in response to a transfer of the first currency unit to a second entity. The second record includes the first currency identifier and a second entity identifier of the second entity and indicates the second entity is the registered owner of the first currency unit, as identified by the first currency identifier. The method also includes storing the second record in the tracking database. The second record is associated with the first record based on the first currency identifier, to track the transfer of the first currency unit represented by the first currency identifier between the first entity and the second entity.

In a further aspect, a non-transitory computer-readable storage medium that includes computer-executable instructions for tracking physical currency is provided. When executed by a computing device including a processor in communication with at least one memory device, the computer-executable instructions cause the processor to store a plurality of currency identifiers in the memory. The plurality of currency identifiers are associated with a respective plurality of physical currency units. Each currency identifier uniquely identifies the respective physical currency unit. The computer-executable instructions also cause to processor to store a plurality of entity identifiers in the memory. The plurality of entity identifiers are associated with a respective plurality of individual currency accounts associated with a respective plurality of entities. Each entity identifier uniquely identifies the respective entity and the respective individual currency account. The computer-executable instructions also cause to processor to create a first electronic record including a first currency identifier of the plurality of currency identifiers and a first entity identifier of the plurality of entity identifiers. The first record indicates that a first entity of the plurality of entities, as identified by the first entity identifier, is a registered owner of first physical currency unit, as identified by the first currency identifier. The computer-executable instructions also cause to processor store the first record in a tracking database. The computer-executable instructions also cause to processor to create a second record, in response to a transfer of the first currency unit to a second entity. The second record includes the first currency identifier and a second entity identifier of the second entity and indicates the second entity is the registered owner of the first currency unit, as identified by the first currency identifier. The computer-executable instructions also cause to processor also stores the second record in the tracking database. The second record is associated with the first record based on the first currency identifier, to track the transfer of the first currency unit represented by the first currency identifier between the first entity and the second entity.

### BRIEF DESCRIPTION OF THE DRAWINGS

FIGS. 1-5 show example embodiments of the methods and systems described herein.

FIG. 1 is a simplified schematic diagram of a currency tracking system including a currency tracking computing device for tracking the transfer of a physical currency unit between entities;

FIG. 2 depicts an example transfer history that may be stored in a currency tracking database, the transfer history including a plurality of currency transfer records indicating the transfer of a physical currency unit between entities;

FIG. 3 is an example process flow diagram of a method for tracking the transfer of a currency identifier representing a physical currency unit between entities;

FIG. 4 illustrates an example configuration of an entity computing device that may be used in the currency tracking system shown in FIG. 1; and

FIG. 5 illustrates an example configuration of the currency tracking computing device that may be used in the currency tracking system shown in FIG.1.

### DETAILED DESCRIPTION

The systems and methods described herein are directed to recording the transfer of physical currency units between entities and, more particularly, assigning specific currency identifiers to specific physical currency units and entity identifiers to individual physical currency accounts (also referred to herein as a digital cash wallets) associated with respective entities, and creating currency transfer records to track transfers of currency units between the entities. Each currency transfer record includes the currency identifiers and entity identifiers associated with each transfer and indicates the physical currency units represented by the currency identifiers are owned by the entity represented by the entity identifier. Each record may also serve to indicate one or more entities that have or previously had ownership of the currency represented by the currency identifier. In the example embodiment, the records are stored in a currency tracking database.

Each currency identifier uniquely identifies a physical currency unit or unit (e.g., bill) of cash. Likewise, the currency identifier may also represent or otherwise identify the value associated with the physical currency unit (e.g., $10.00, €5,00, etc.). The physical currency unit represented by the currency identifier may display the currency identifier thereon. For example, the currency identifier may be stamped or printed on the physical currency unit. In some embodiments, the currency identifier is a serial number or an alphanumeric code including any number of characters and printed on the currency unit by a federal or national agency when the currency unit is first printed or commissioned. Alternatively or additionally, the currency identifier may include a QR code, a bar code, or any other identifier that may be used to uniquely identify a physical currency unit. Additionally or alternatively, the currency identifier may be a water mark or non-visible marker, e.g., stored in a magnetic stripe.

The currency identifier may also include identifiers that provide additional information regarding the corresponding physical currency unit. For example, the currency identifier may indicate the value of the physical currency unit (e.g., a physical currency unit with a value of $500.00 may have a currency identifier that includes 500-XXX). Additionally or alternatively, the currency identifier may indicate the year of printing of the physical currency unit by the Federal Reserve or other federal or national currency printing agency. For example, a physical currency unit printed in 2020 may have a currency identifier that includes XXX-2020.

Each entity identifier uniquely identifies an individual currency account associated with a respective entity. An entity may include, for example and without limitation, an individual consumer or person, a merchant or business, and/or a financial institution. Entities may enroll in the currency tracking system by authorizing the currency tracking system to access and record currency transfers made by the entity. Upon enrollment in the currency tracking system, the entity is issued an entity identifier used to uniquely identify the entity and/or an individual currency account associated with the respective entity. The entity identifier may also that provide additional information associated with the entity. For example, individual entities may be issued an entity identifier indicating the entity is an individual person. Alternatively, merchants or businesses may be issued an entity identifier that indicates the entity identifier is a business. The entity identifier may include an alphanumeric code including any number of characters.

In the example embodiment, a first entity may wish to record the transfer and acceptance of a physical currency unit, such as a paper bill of a currency (also referred to herein as cash) to a second entity. A first currency identifier is assigned to or associated with the physical currency unit and is stored in a memory (e.g., the currency tracking database or another database). Likewise, first and second entity identifiers are respectively assigned to the first entity and the second entity and are stored in a memory (e.g., the currency tracking database or another database). The first entity, identified by the first entity identifier, surrenders the first currency to the second entity (e.g., as payment or transfer, etc.). The second entity, identified by the second entity identifier, accepts the first currency.

The currency tracking system is communicatively coupled to a plurality of entity computing devices respectively associated with the plurality of entities. Each entity computing device has an instance of a digital wallet stored thereon. The digital wallet is associated with the respective individual currency account of the corresponding entity. The entity computing device may include, for example and without limitation, a cellular phone (e.g., a smart phone), laptop, or other computing device associated with the entity. An entity may use the entity computing device to transmit and/or receive messages with the currency tracking system in order to perform at least one of storing a currency identifier to a digital currency account, initiating a transfer of a currency identifier to another entity, and/or accepting a currency identifier from another entity.

In some embodiments, the entity computing device may include an application stored and/or executable thereon to facilitate communications with the currency tracking system. For example, the entity computing device may use a web-based system supported by the currency tracking system to facilitate communications with the currency tracking system. In some embodiments, the entity computing device may include and/or be communicatively connected to a camera, enabling the entity to capture an image of a currency identifier and/or an entity identifier to provide the currency identifier and/or entity identifier to the currency tracking system. For example, an entity may use a camera application on their mobile device to capture a picture of a currency unit, which may have printed thereon a serial number or a QR code, representing the currency identifier. Additionally, the entity may use their entity computing device transmit a transfer initiation message to the currency tracking system. The transfer initiation message may include one or more entity identifiers and at least one currency identifier.

For example, the first entity or the second entity may use their entity computing device to transmit a first transfer initiation message, the first transfer initiation message including the first entity identifier, the second entity identifier, a first currency identifier of the physical currency unit being transferred, and a request to transfer the first currency identifier from the first entity to the second entity. In response to the first transfer initiation message, received from at least one entity computing device, the currency tracking system creates a new currency transfer record representing the transfer of the first currency unit between the first and second entities and stores the new record in the currency tracking database. The new record includes the first entity identifier, the second entity identifier, the first currency identifier, and indicates that the first currency unit (represented by the first currency identifier) is now owned by the second entity. Additionally, the new currency transfer record may indicate that the first currency unit (represented by the first currency identifier) was previously owned by the first entity. In other words, each individual record contains data that identifies the current entity that is a registered or recorded owner of the currency unit, and the entity that was previously the recorded owner of the currency unit.

In some cases, the first entity transfers multiple currency units to the second entity (e.g., three physical bills), and the first and/or second entity may use their entity computing device(s) to generate a transfer initiation message that includes the currency identifiers of all of the currency units. In response to receiving such a transfer initiation message, the currency tracking system may generate a plurality of currency transfer records, each currency transfer record representing the transfer of one of the physical currency units. In an alternative embodiment, the currency tracking system may generate a single currency transfer record that includes all of the currency identifiers. That record may be stored in each of the transfer histories respectively associated with each of the currency identifiers.

The physical currency unit has an associated value, and in some embodiments, the first entity wishes to only transfer a portion of the value to the second entity. For example, the first entity may have recorded ownership of a first currency unit having a value of $100.00. The first entity may use their entity computing device to transmit a transfer initiation message to the currency tracking system. The transfer initiation message includes the first entity identifier of the first entity, the second entity identifier of the second entity, a first currency identifier identifying the first currency unit of $100.00, and a request to transfer only a portion of the value, such as $25.00, to the second entity. In response to the transfer initiation message, the currency tracking system issues two new currency identifiers, a first new currency identifier associated with a value of $25.00 and a second new currency identifier associated with a value of $75.00. The two new currency identifiers replace the original currency identifier. The individual values associated with the new identifiers sum to the value associated with the original identifier.

Additionally, the currency tracking system generates two new currency transfer records, a first currency transfer record and a second currency transfer record, and stores the two new currency transfer records to the currency tracking database. The first new currency transfer record includes the first new currency identifier representing the first, transferred portion of the original value of the physical currency unit, the first entity identifier, and the second entity identifier, indicating that the second entity is the registered owner of the first new currency identifier. Likewise, the second new currency transfer record includes the second new currency identifier representing the second, untransferred portion and the first entity identifier, indicating that the first entity is the registered owner of the second new currency identifier. The new currency transfer records may also include the original currency identifier or may be stored as part of the transfer history of the original currency identifier, and/or may be stored in separate transfer histories but be associated with the transfer history of the original currency identifier. The currency tracking system may also store the first new currency identifier to the digital currency account of the second entity and store the second new currency identifier in the digital currency account of the first entity.

A specific currency unit may be transferred on multiple occasions between entities; each time the currency is transferred, a new record including the currency identifier and representing the respective transfer is generated and stored. Accordingly, the currency tracking database stores a transfer history for each currency identifier, the transfer history including all currency transfer records associated with the transfer history of the same currency identifier.

The plurality of records contained in the transfer history may be embodied as a blockchain wherein each record is a block, and wherein adj acent records indicate one or more previous entities that had previous ownership of the currency unit and the entity that subsequently received the currency unit from the previous entity. The transfer history may be used to trace a payer and a payee for each instance that the currency unit was transferred between entities. Accordingly, the final record indicates the entity is the current owner of the currency unit.

In some example embodiments, the currency tracking system may store a transfer history for each currency identifier of the plurality of currency identifiers. Each transfer history includes a plurality of currency transfer records including the same currency identifier. Alternatively or additionally, the currency tracking system may store a transfer history for each entity identifier of the plurality of entity identifiers. Each transfer history includes a plurality of currency transfer records including the same entity identifier.

The system and processes described herein are implemented by transmitting and receiving a plurality of messages between one or more components including, one or more entities (including a computing device thereof), a currency tracking system, and a payment processing network. The currency tracking system includes a currency tracking computing device communicatively coupled to the currency tracking database. The currency tracking computing device is configured to build or populate the currency tracking database by storing one or more currency transfer records therein. In some example embodiments, the currency tracking computing device may receive information to be stored as currency transfer records from a payment processing network that extracts data from transfer initiation messages routed over the payment processing network. Alternatively, a computing device of the payment processing network may be configured to build or populate one or more currency transfer records from the extracted data and store the currency transfer records to the currency tracking database.

In some embodiments, currency transfer records may include indices that indicate the order in which each currency transfer record was created and its relation to other currency transfer records contained in the same transfer history. For example, a transfer history may include a total of “n” records. A first record may be labeled with an index of 1 and a subsequent adjacent record may be labeled with an index of 2, and so forth, to the “n^{th}” record. The labeling may indicate the order of ownership of the physical currency unit and/or indicate the number of occasions of transfer of ownership of the currency unit. For example, a first record may include the label “n” and a later record may be labeled “n+10” which indicates that 10 occasions of ownership transfer of the currency identifier occurred between the record labeled “n” and the record labeled “n+10”.

The currency tracking system may further maintain or support a software application (“app”) executable on the entity computing devices, the app enabling communication between the entity computing device and the currency tracking computing device, for example, via an application program interface (API). Additionally or alternatively, the API may be executed on a web browser. The API may enable an entity computing device to transmit information to and/or access information from the currency tracking computing device. The app may further enable the entity to access their digital wallet and/or digital currency account, including accessing information regarding one or more currency identifiers stored therein. In some cases, the entity may need to login to the app by providing log-in credentials (e.g., a user name, a password, a biometric identifier, etc.).

The app may also enable the transfer of currency identifier(s) between one or more entities. More specifically, the entity may use the app to identify a currency identifier (and/or corresponding physical currency unit) during a transfer thereof. In some embodiments, the app may be communicatively coupled to a camera of the entity computing device, (e.g., a camera of a mobile phone) such that the camera may be used to capture an image of the currency identifier. The app may include optical character recognition (OCR) and/or other image processing capabilities that enable the app to extract the currency identify from a captured image.

In some example embodiments, upon receipt of a physical currency unit, an image of the serial number, bar code, QR code, or the like representing the currency identifier may be captured by the app (e.g., via the camera) and directly entered to the digital currency account. Additionally or alternatively, the currency identifier (e.g., a serial number or other alphanumeric code) may be manually entered by an entity, for example, in a fillable field of a form displayed within a user interface of the app.

In some cases, if a currency identifier is already registered to another owner, the app may prevent or block the currency identifier from being added to a digital currency account not associated with the owner. For example, the entity computing device may transmit the currency identifier (e.g., via the API in a transfer initiation request) to the currency tracking computing device, and the currency tracking computing device may perform a lookup in the currency tracking database to confirm and/or verify that a transfer initiation request is initiated by and/or includes the entity identifier of the registered owner of the currency identifier. If a transfer initiated request is initiated by an entity that is not the registered owner of the currency identifier, the currency tracking system may (i) transmit a confirmation request to the entity computing device of the registered owner of the currency identifier, requesting confirmation that the transfer is legitimate, or (ii) decline or cancel the transfer initiation request.

In some example embodiments, an entity may have possession or ownership of the physical currency unit and have the currency identifier stored within their digital currency account. In other words, the entity may have possession of the physical currency unit as well as the digital representation of the currency unit. If a first entity transfers ownership of the currency to a second entity, the first entity is required to both physically transfer (e.g., surrender) the physical currency unit and digitally transfer the associated currency identifier. In other words, the first entity may give the second entity the physical cash as well as surrender the digital representation of the cash to the second entity.

In some example embodiments, a physical currency unit may be consigned or “turned in” in exchange for creating a digital-only currency identifier that identifies the consigned physical currency unit. For example, an entity may consign a physical currency unit by turning in the physical currency unit to the Federal Reserve or other federal and/or national currency printing agency, or to another designated approved entity. Designated approved entities are enrolled with the currency tracking system and are approved to act as intermediaries between entities and the Federal Reserve or other federal or national currency printing agencies to accept physical currency units and (at least temporarily) withdraw the physical currency units from circulation.

In some such embodiments, the currency tracking system may receive a currency consignment message from an approved entity. The consignment message may be associated with a first physical currency unit identified by a first currency identifier. The currency consignment message includes the first currency identifier and an indication that the first physical currency unit has been consigned to the approved entity. The currency computing system stores a consignment record in the currency tracking database. The consignment record includes the first currency identifier and a consignment flag. The currency tracking system may also amend the first currency identifier such that the first currency identifier indicates that there is no physical currency unit associated with further transfer of that first currency identifier between digital accounts. For example, the currency tracking computing device may amend the first currency identifier with an asterisk or other prefix or suffix. In response to a transfer initiation message, the currency tracking computing device may query the currency tracking database to determine whether the currency identifier being transferred has been consigned. Additionally, the currency tracking computing device may transmit a notification message to one or more of the entities involved in the transfer, indicating whether the currency identifier has been consigned. Accordingly, a transfer may include a digital-only transfer where there is no exchange of the physical currency unit, and the transfer only includes the digital transfer of the currency identifier between two entities.

In some cases, a new or updated currency identifier representing the consigned physical currency unit is created, and this updated currency identifier is stored with the digital currency account of the entity that consigned the physical currency unit. In other cases, a new currency identifier is not issued, but the currency transfer record in the transfer history for the original currency identifier includes the consignment flag, indicating that the physical currency unit was consigned. The physical currency unit may eventually be re-circulated, at which stage the currency tracking computing device may initiate a new transfer history for the currency identifier, or a new currency transfer record may be added to the original transfer history, the new record indicating that the physical currency unit is being re-circulated. Another “branch” of the transfer history may record digital-only transfers of the currency identifier.

At least one technical problem to be solved by the systems and methods provided herein includes: (i) inability to create a digital representation of a physical currency unit, (ii) the inability to record a transfer, including surrendering and acceptance, of a physical currency unit between two entities, and (iii) inability to track a plurality of transfers of a physical currency unit between a plurality of entities.

The technical effect of the systems and processes described herein may achieved by performing at least one of the following steps: (i) storing a plurality of currency identifiers in the memory, the plurality of currency identifiers associated with a respective plurality of physical currency units, (ii) storing a plurality of entity identifiers in the memory, the plurality of entity identifiers associated with a respective plurality of individual currency accounts associated with a respective plurality of entities, (iii) creating a first electronic record including a first currency identifier and a first entity identifier, indicating that a first entity is a registered owner of first physical currency unit, (iv) storing the first record in a tracking database, (v) creating a second record, in response to a transfer of the first currency unit to a second entity, wherein the second record indicates the second entity is the registered owner of the first currency unit, as identified by the first currency identifier, and (vi) storing the second record in the tracking database, the second record associated with the first record, to track the transfer of the first currency unit represented by the first currency identifier between the first entity and the second entity.

A technical effect or improvement provided by the systems and processes described herein include at least one of: (i) enabling the creation of a digital representation of a physical currency unit by assigning a currency identifier to a physical currency unit that uniquely identifies the physical currency unit, (ii) enabling recording of the transfer, including surrendering and acceptance, of a physical currency unit between entities, and (iii) enabling centralized and consolidated recording of a plurality of transfers of the physical currency unit between a plurality of entities.

As used herein, a processor may include any programmable system including systems using micro-controllers, reduced instruction set circuits (RISC), application specific integrated circuits (ASICs), logic circuits, and any other circuits or processor capable of executing the functions described herein.

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and thus are not limiting as to the types of memory usable for saving of a computer.

In one embodiment, a computer program is provided, and the program is embodied on a computer readable medium. In an example embodiment, the data optimization system is executed on a single computer system, without requiring a connection to a server computer. In a further embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

As used herein, the terms “transaction card,” “financial transaction card,” and “payment card” refer to any suitable transaction card, such as a credit card, a debit card, a prepaid card, a charge card, a membership card, a promotional card, a frequent flyer card, an identification card, a prepaid card, a gift card, a card that is part of a digital wallet, and/or any other device that may hold payment account information, such as mobile phones, smartphones, personal digital assistants (PDAs), key fobs, and/or computers. Each type of transaction card can be used as a method of payment for performing a transaction. As used herein, the term “payment account” is used generally to refer to the underlying account associated with the transaction card.

The following detailed description illustrates embodiments of the disclosure by way of example and not by way of limitation. It is contemplated that the disclosure has general application to processing financial transaction data by a third party in industrial, commercial, and residential applications.

As used herein, an element or step recited in the singular and proceeded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

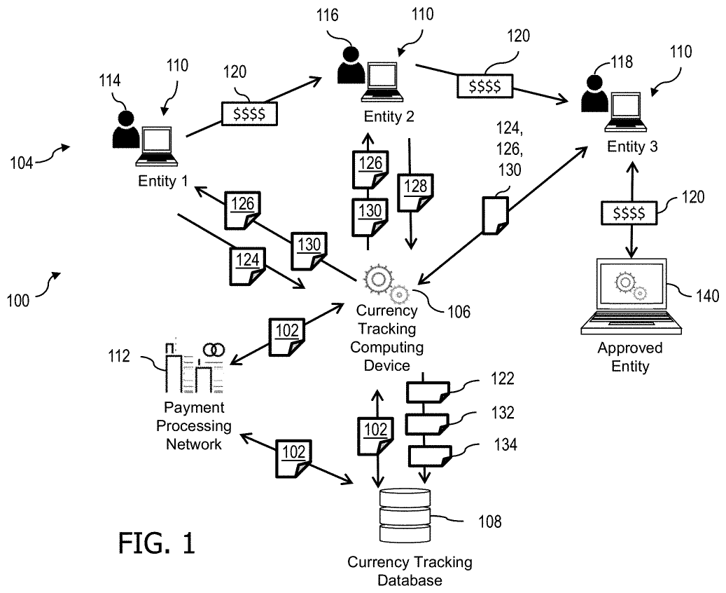

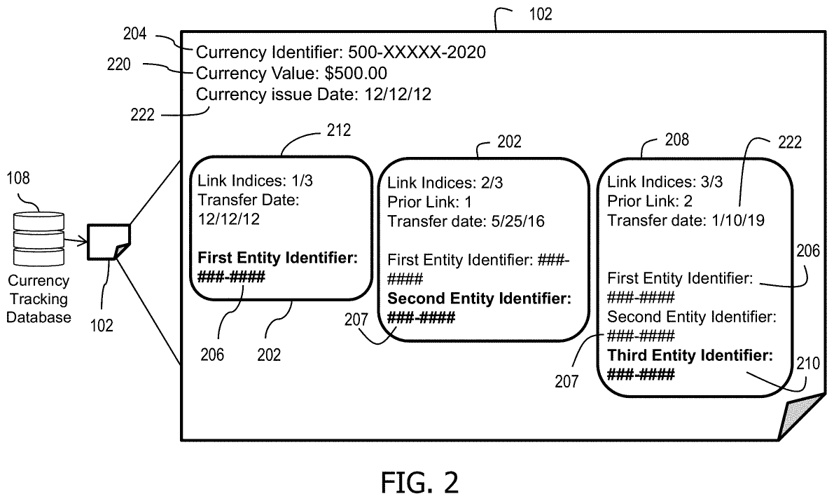

FIG. 1 is a schematic diagram of an example currency tracking system 100 for generating and storing one or more transfer histories 102 including one or more electronic currency transfer records (e.g., currency transfer records 202, shown in FIG. 2) in accordance with the present disclosure. The one or more currency records contained in each transfer history 102 track and record the transfer of a physical currency unit between one or more entities 104.

Currency tracking system 100 includes a currency tracking computing device 106 that is communicatively coupled to a currency tracking database 108. Currency tracking computing device 106 is communicatively coupled to a plurality of entity computing devices 110 respectively associated with the plurality of entities 104. Each entity computing device 110 has an instance of a digital wallet stored thereon. The digital wallet associated with the respective individual currency account of the corresponding entity 104. Currency tracking computing device 106 is configured to receive a transfer initiation message from an entity computing device 110 of at least one of the entities 104. Entity computing device 110 may include, for example and without limitation, a cellular phone, laptop, and/or other computing devices associated with the entity.

Currency tracking computing device 106 is further communicatively coupled to one or more payment processors (not shown) of a payment processing network 112. Payment processing network 112 includes a set of proprietary communications standard for the exchange of financial transaction data and the settlement of funds between financial institutions. In some embodiments, payment processing network 112 is configured to receive and/or process transfer initiation messages for entities 104. As used herein, “payment processing network” refers broadly to the network and/or to one or more computing devices associated therewith (e.g., payment processors or payment processing computing devices). In some example embodiments, currency tracking system 100 may be integral to and/or otherwise associated with payment processing network 112.

In the illustrated embodiment, one or more entities 104 previously enrolled or registered with currency tracking system 100. Currency tracking system 100 (e.g., currency tracking computing device 106) assigned an entity identifier to each of the one or more entities 104 to uniquely identify the respective entity 104. Each entity identifier is associated with one of an individual person, a financial institution, and a merchant. One or more entities 104 include a first entity 114, a second entity 116, and a third entity 118. Each of the entity identifiers assigned to the one or more entities is also assigned to and/or associated with a digital currency account (also referred to herein as a digital cash wallet) associated with the respective entity. Currency tracking computing device 106 stores the plurality of entity identifiers in a memory thereof and/or within currency tracking database 108.

Currency tracking computing device 106 also stores currency identifiers assigned to a plurality of physical currency units. Each currency identifier is associated with and uniquely identifies a respective one of the physical currency units. The physical currency unit may be a paper currency bill having an associated value. As described above, the currency identifier may include an alphanumeric code, a bar code, a QR code, and the like. In some example embodiments, the currency identifier is displayed on the physical currency unit. In the illustrated embodiment, a first physical currency unit (not shown) has a first currency identifier 120. Currency tracking computing device 106 stores the plurality of currency identifiers in the memory and/or the currency tracking database 108.

In the illustrated embodiment, first entity 114 is the recorded or registered owner of the first physical currency unit identified by first currency identifier 120. Currency tracking computing device 106 generates a first electronic currency transfer record 122 including the first currency identifier 120 and the first entity identifier. First record 122 indicates that first entity 114, as identified by the first entity identifier, is the registered owner of the first physical currency unit, as identified by the first currency identifier 120. Currency tracking computing device 106 stores first record 122 to the memory and/or within currency tracking database 108.

First entity 114 may use their entity computing device 110 to transmit and receive a plurality of messages with currency tracking computing device 106. For example, first entity 114 may transmit a message to currency tracking computing device 106 to initiate storing a digital currency within a digital currency account associated with first entity 114, initiate the transfer of a digital currency with another entity (e.g., second entity 116 or third entity 118), and/or accept a transfer of a digital currency from another entity. In response to messages received from entity computing device 110, currency tracking computing device 106 may generate and store electronic currency transfer records to currency tracking database 108 and/or store a currency identifier within a digital currency account.

In some example embodiments, currency tracking system 100 may maintain or support a software application (“app”) executable on entity computing devices 110, the app enabling communication between entity computing devices 110 and currency tracking computing device 106, for example, via an application program interface (API). Additionally or alternatively, the app may be executed on a web browser. The app (e.g., via the API) may enable an entity computing device 110 to transmit information to and/or access information from currency tracking computing device 106. The app may further enable the entity 104 to access their digital wallet and/or digital currency account, including accessing information regarding one or more currency identifiers stored therein. Further, entity 104 may initiate a transfer of a currency identifier to other entities using the app, by providing an entity identifier of the other entity and currency identifer(s) of currency units being transferred.

First entity 114 initiates the transfer of first currency identifier 120 to second entity 116 by providing the second entity identifier and currency identifier 120 to the app. In some other example embodiments, second entity 116 initiates the transfer, by providing the first entity identifier and currency identifier 120 to the app, and first entity 114 may confirm the request for the transfer that was initiated by second entity 116.

In the illustrated embodiment, first entity 114 initiates the transfer using the app executed on their entity computing device 110. The app facilitates the transmission of a first transfer initiation message 124 to currency tracking computing device 106. First transfer initiation message 124 includes first currency identifier 120, the second entity identifier identifying second entity 116, the first entity identifier identifying first entity 114, and a request to transfer ownership of first currency identifier 120 from first entity 114 to second entity 116 (representing a transfer of the first currency unit from first entity 114 to second entity 116).

In response to first transfer initiation message 124, currency tracking computing device 106 transmits a notification message 126 to second entity 116. Notification message 126 may be displayed on a user interface of the app executed on the entity computing device 110 associated with second entity 116. Notification message 126 indicates that first entity 114 has initiated a transfer of first currency identifier 120 (representing the transfer of the first currency unit) to second entity 116. Notification message 126 may include additional or alternative data, for example, a value associated with the first physical currency unit identified by first currency identifier 120. Notification message 126 may also prompt second entity 116 to either approve or decline the transfer of currency identifier 120 (representing whether second entity 116 has accepted and received the first currency unit). If second entity 116 accepts first currency identifier 120, second entity 116 uses the app to transmit a confirmation message 128 to currency tracking computing device 106. Confirmation message 128 includes an approval from second entity 116, indicating that second entity 116 has accepted the transfer initiated by first entity 114.

In some example embodiments, first entity 114 may have possession of the first physical currency unit assigned to first currency identifier 120 and, accordingly, first entity 114 may also surrender the first physical currency unit to second entity 116 during transfer of first currency identifier 120. In some cases, notification message 126 may indicate if there exists a physical currency unit that needs to be transferred in order to complete transfer of first currency identifier 120. For example, a physical currency unit may be consigned, such that there is only a digital representation of the currency unit as identified by the currency identifier. In some example embodiments, only the currency identifier 120 is transferred, representing a digital-only transfer. In a digital-only transfer, only the value of the physical currency unit originally associated with the first currency identifier 120 is transferred. In such cases, the digital-only transfer involves the digital transfer of currency identifier 120 between first entity 114 and second entity 116 (without a corresponding transfer of a physical currency unit).

Upon completion of the transfer of first currency identifier 120, in some embodiments, currency tracking computing device 106 transmits a finalization message 130 to the entity computing device 110 associated with at least one of first entity 114 and/or second entity 116. The app may display finalization message 130 and prompt first entity 114 and/or second entity 116 to confirm the finalization of the transfer. For example, finalization message 130 may prompt second entity 116 to confirm that they received a physical currency unit during the transfer. In addition, finalization message 130 may serve as to verify the transfer is complete.

Currency tracking computing device 106 also removes first currency identifier 120 from the digital currency account associated with first entity 114, and stores first currency identifier 120 to the digital currency account associated with second entity 116.

In addition, upon transfer of first currency identifier 120, currency tracking computing device 106 generates a second currency transfer record 132. Second currency transfer record 132 includes first currency identifier 120 and the second entity identifier of second entity 116, indicating second entity 116 is the registered owner of first currency identifier 120. Second currency transfer record 132 may also indicate that second entity 116 received first currency identifier 120 from first entity 114 (e.g., by including the first entity identifier of first entity 114). Currency tracking computing device 106 stores second currency transfer record 132 to the memory and/or currency tracking database 108.

Subsequently, first currency identifier 120 may be transferred from second entity 116 to third entity 118 identified by a third entity identifier. Third entity 118 is assigned to a third entity identifier identifying the third entity 118 and a digital currency account associated with third entity 118. Second entity 116 and third entity 118 may utilize the app, executed on their respective entity computing device 110, to complete the transfer of ownership of first currency identifier 120, by transmitting one or more of transfer initiation request message 124, confirmation message 128, and or finalization message 130 with the currency tracking computing device 106, as described above.

Likewise, upon completion of the transfer of first currency identifier 120 to third entity 118, currency tracking computing device 106 generates a third currency transfer record 134 including first currency identifier 120 and the third entity identifier, indicating third entity 118 is the registered owner of first currency identifier 120. Currency tracking computing device 106 stores third currency transfer record 134 to the memory and/or currency tracking database 108. Additionally, currency tracking computing device 106 removes first currency identifier 120 from the digital currency account associated with second entity 116 and stores first currency identifier 120 in the digital currency account associated with third entity 118.

In some cases, the first physical currency unit and first currency identifier 120 may be transferred any number of times between any number of entities 104. Each time the first physical currency unit and/or first currency identifier 120 is transferred, currency tracking computing device 106 generates a new electronic currency transfer record and stores the new currency transfer record to the memory and/or currency tracking database 108.

In the example embodiment, currency tracking system 100 includes a plurality of designated approved entities 140. Each approved entity 140 may include the Federal Reserve or other federal or national currency printing agencies and/or other entities which have been approved and authorized to act as an intermediaries with the Federal Reserve or other federal or national currency printing agencies to accept physical currency units and (at least temporarily) withdraw the physical currency units from circulation. For example, third entity 118 may have possession of the first physical currency unit as well as first currency identifier 120 stored within the digital currency account associated with third entity 118. Third entity 118 may consign the first physical currency unit with the approved entity 140, thereby removing the physical currency unit from circulation and from the transfer process.

Approved entity 140, enrolled with currency tracking system 100, is authorized to accept a physical currency unit for consignment. Approved entity 140 may transmit and receive one or more messages with currency tracking computing device 106 to facilitate consignment of a physical currency unit. Approved entity 140 may transmit a consignment message to currency tracking computing device 106, the consignment message including an entity identifier and the currency identifier of the physical currency unit that is being consigned. In response to the consignment message, currency tracking computing device 106 creates an electronic currency consignment record and stores the currency consignment record in the currency tracking database 108. The currency consignment record includes the currency identifier of the consigned physical currency unit and the entity identifier, indicating that the entity is the registered owner of the currency identifier but not of the physical currency unit. The consignment currency record may also include a consignment flag to indicate that the physical currency unit has been consigned.

FIG. 2 illustrates an example embodiment of a transfer history 102 including a plurality of currency transfer records 202. In this illustrated embodiment, transfer history 102 is stored within a currency tracking database (e.g., currency tracking database 108, shown in FIG. 1). Transfer history 102 is associated with a physical currency unit having a currency identifier 204 assigned thereto that uniquely identifies the physical currency unit. Each currency transfer record 202 contained within transfer history 102 identifies a transfer of the currency unit represented by currency identifier 204 between one or more entities (e.g., entities 104, shown in FIG. 1). In other words, transfer history 102 contains data indicating a chain of ownership of currency identifier 204 between a plurality of entities.

The example transfer history 102 illustrated in FIG. 2 includes three currency transfer records 202. Each currency transfer record 202 identifies one or more entities that was previously a recorded or registered owner of currency identifier 204 (and, therefore, the associated physical currency unit). Specifically, each currency transfer record 202 includes a respective entity identifier of each of these one or more previous owners. A final or current currency transfer record 208 of currency transfer records 202 identifies the current recorded owner of currency identifier 204. Specifically, final currency transfer record 208 includes an entity identifier 210 of the current recorded owner. In this example, final currency transfer record 208 indicates that a third entity identified by third entity identifier 210 is the current recorded owner, and accordingly, currency identifier 204 is also stored within a digital currency account associated with the third entity. Final currency transfer record 208 also indicates that the previous owner of currency identifier 204 was a second entity identified by a second entity identifier 207. Further, in this illustrated embodiment, final currency transfer record 208 also indicates that prior to the second entity having ownership of currency identifier 204, a first entity represented by a first entity identifier 206 owned currency identifier 204 (and the associated physical currency unit).

In this illustrated embodiment, transfer history 102 also includes a first currency transfer record 212. Currency tracking computing device 106 (shown in FIG. 1) generates first currency transfer record 212, first currency transfer record 212 including first entity identifier 206 indicating that the first entity was the registered owner of the first currency unit identified by currency identifier 204. Currency tracking computing device 106 stores first currency transfer record 212 to currency tracking database 108. In some cases, first currency transfer record 212 may have been generated by currency tracking computing device 106 in response to the commission/circulation of the physical currency unit identified by currency identifier 204.

Transfer history 102 also includes additional data. For example, transfer history 102 includes a value 220 indicating the value of the physical currency unit identified by currency identifier 204. In this example, value 220 is $500.00, indicating that the physical currency unit identified by currency identifier 204 has a monetary value of $500.00. Transfer history 102 may also include a time 222 indicating a date of a most recent transfer of currency identifier 204 and/or the date that currency identifier 204 was issued or printed. In this example, time 222 includes a currency issue date of Dec. 12, 2012. Additionally, transfer history 102 includes a transfer date of final currency transfer record 208 including Jan. 10, 2019, indicating that a third entity identified by third entity identifier 210 accepted the transfer of the currency unit identified by currency identifier 204 from a second entity identified by second entity identifier 207 on Jan. 10, 2019. In other example embodiments, transfer history 102 may include additional or alternative data that enables the currency tracking computing device 106 to function as described herein. Moreover, in some embodiments, individual currency transfer records 202 may include any of the data described herein as being included in transfer history 102.

Transfer history 102 may be embodied as a blockchain structure in which each individual currency transfer record 202 is a block. Adjacent currency transfer records 202 indicate one or more previous entities that had previous ownership of the currency unit identified by currency identifier 204 and the entity that subsequently received the currency unit from the previous entity. Transfer history 102 may be used to trace a payer and a payee for each instance that the currency unit was transferred between entities. Transfer history 102 may alternatively be embodied as a table and/or a tree structure in which entries include currency transfer records 202. In other example embodiments, transfer history 102 may include any other suitable electronic data structure.

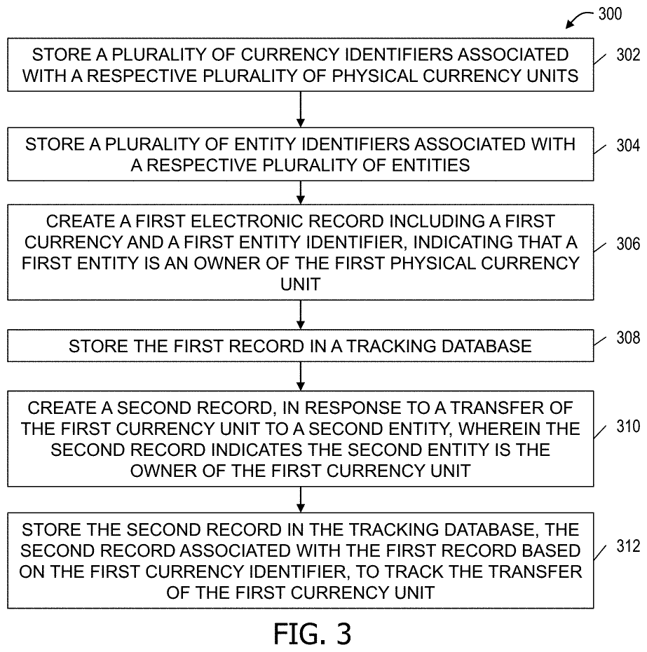

FIG. 3 is an example process flow diagram of a method 300 for tracking the transfer of a currency identifier (e.g., a currency identifier 120, shown in FIG. 1) representing a physical currency unit between entities (e.g., entities 104, also shown in FIG. 1). Method 300 may be implemented by a currency tracking computing device (e.g., currency tracking computing device 154, shown in FIG. 1). The currency tracking computing device is communicatively coupled to a currency tracking database (e.g., currency tracking database 156) configured to generate and record a transfer history (e.g., transfer history 102, both shown in FIG. 1) including one or more currency transfer records (e.g., currency transfer record 202, shown in FIG. 2). Each individual currency transfer record represents an occasion that the currency identifier (and the associated physical currency unit, except in the case of digital-only transfer) was transferred between two entities. In some example embodiments, the currency tracking system may be integral to and/or otherwise associated with a payment processing network (e.g., payment processing network 112, shown in FIG. 1).

Method 300 includes storing 302 a plurality of currency identifiers in the memory and/or the currency tracking database. The plurality of currency identifiers are associated with a respective plurality of physical currency units. Each currency identifier uniquely identifies the respective physical currency unit.

Method 300 further includes storing 304 a plurality of entity identifiers in the memory and/or the currency tracking database, the plurality of entity identifiers associated with a respective plurality of individual digital currency accounts associated with a respective plurality of entities. Each entity identifier uniquely identifies the respective entity and the respective individual digital currency account. The entity identifier may be associated with an individual person, a financial institution, and/or a merchant. The plurality of digital currency accounts are associated with a respective plurality of entities, enabling an entity to digitally deposit a currency identifier and/or surrender a currency identifier to another entity.

Method 300 further includes creating 306 a first currency transfer record including a first currency identifier of the plurality of currency identifiers and a first entity identifier of the plurality of entity identifier. The first currency transfer record indicates the first entity of the plurality of entities, as identified by the first entity identifier, is the registered owner of the currency identifier. In some example embodiments, the first entity may have possession of a physical currency unit as identified by the first currency identifier.

Method 300 further includes storing 308 the first currency transfer record in the currency tracking database and/or the memory. In some example embodiments, storing 308 may include storing the first currency transfer record as part of a transfer history. Each currency transfer record in the transfer history includes the same currency identifier.

Method 300 also includes creating 310 a second currency transfer record in response to a transfer of the first currency unit to a second entity. The second record includes the first currency identifier and a second entity identifier of the second entity and indicates the second entity is the registered owner of the first currency identifier. In some example embodiments, the second entity may have possession of a physical currency unit as identified by the first currency identifier. Alternatively, the second entity may not have possession of a physical currency unit as identified by the first currency identifier.

Method 300 also includes storing 312 the second currency transfer record in the currency tracking database and/or the memory. The second record is associated with the first record based on the first currency identifier, to track the transfer of the first currency unit represented by the first currency identifier between the first entity and the second entity.

In some example embodiments, method 300 further includes recording the transfer of a portion of the value associated with the first currency identifier, between the first entity and the second entity by assigning a new currency identifier to the portion of the value transferred and a second new currency identifier to a portion of the value not transferred. The currency tracking computing device stores two new currency transfer records to the currency tracking database and/or the memory. The two new currency transfer records include a first new currency transfer record and a second new currency transfer record. The first new currency transfer record includes the first new currency identifier identifying the portion of the value transferred to the second entity and the second entity identifier, indicating the second entity is the registered owner of the value transferred. The second new currency transfer record includes the second new currency identifier associated with the portion of the value not transferred and the first entity identifier, indicating that the first entity is the registered owner of the portion of the value not transferred.

In some example embodiments, method 300 further includes closing a transfer history and/or a currency transfer record associated with a currency identifier, for example, based on the physical currency unit associated with the first currency identifier being consigned with the Federal Reserve or another approved entity. An approved entity includes an entity that is enrolled with the currency tracking system and approved to act as an intermediary between the entities and the Federal Reserve to receive physical currency units and (at least temporarily) remove the physical currency units from circulation. In some such embodiments, method 300 further includes receiving a currency consignment message associated with the first physical currency unit. The currency consignment message includes the first currency identifier and indicates the first physical currency unit has been consigned to an approved entity. The currency tracking computing device stores a consignment record in the tracking database, the consignment record including the first currency identifier and a consignment flag.

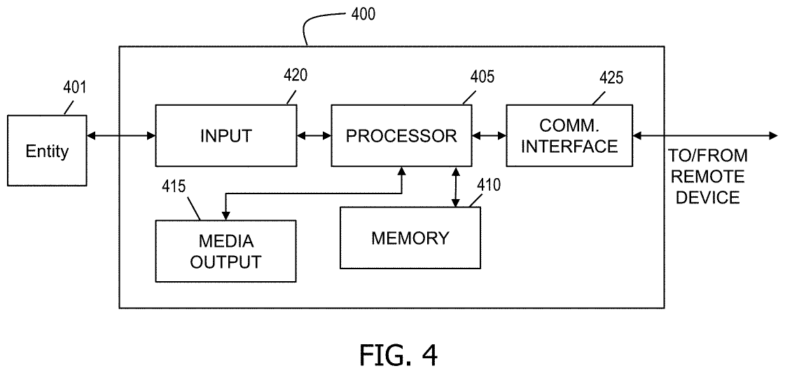

FIG. 4 illustrates an example configuration of an entity computing device 400, such as entity computing device 110 shown in FIG. 1. Entity computing device 400 may include a laptop, tablet, and/or mobile phone associated with an entity registered with currency tracking system 100 (shown in FIG. 1). In the example embodiment, entity computer device 400, operated by an entity 401 (e.g., entity 104 shown in FIG. 1). Entity computer device 400 includes a processor 405 for executing instructions, and a memory 410. In some embodiments, executable instructions are stored in memory 410. Processor 405 may, for example, include one or more processing units (e.g., in a multi-core configuration). Memory 410 may, for example, be any one or more devices allowing information such as executable instructions or transaction data to be stored and retrieved. Memory 410 may further include one or more computer readable media.

In the example embodiment, entity computer device 400 further includes at least one media output component 415 for presenting information to entity 401. Media output component 415 may, for example, be any component capable of converting and conveying electronic information to entity 401. In some embodiments, media output component 415 includes an output adapter (not shown), such as a video adapter or an audio adapter, which is operatively coupled to processor 405 and operatively coupleable to an output device (also not shown), such as a display device (e.g., a cathode ray tube (CRT), liquid crystal display (LCD), light emitting diode (LED) display, or “electronic ink” display) or an audio output device (e.g., a speaker or headphones).

In some embodiments, media output component 415 is configured to include and present a graphical user interface such as a web browser or a client application, to entity 401. The graphical user interface may include, for example, an online store interface for viewing or purchasing items, or a digital currency account application for managing payment information. In some embodiments, entity computer device 400 includes an input device 420 for receiving input from entity 401. Entity 401 may use input device 420, without limitation, to select or enter one or more items to purchase or request to purchase, to access credential information, or to access payment information. Input device 420 may include, for example, a keyboard, a pointing device, a mouse, a stylus, a touch sensitive panel (e.g., a touch pad or a touch screen), a gyroscope, an accelerometer, a position detector, a biometric input device, or an audio input device. A single component such as a touch screen may function as both an output device of media output component 415 and input device 420. In this illustrated embodiment, media output component 415 may support an application program interface (API) associated with a digital currency account identified by an entity identifier. Entity 401 may access the contents of the digital currency account using input device 420 in order to initiate a transfer of a currency identifier to another entity. In addition, entity 401 may accept a currency identifier using input device 420.

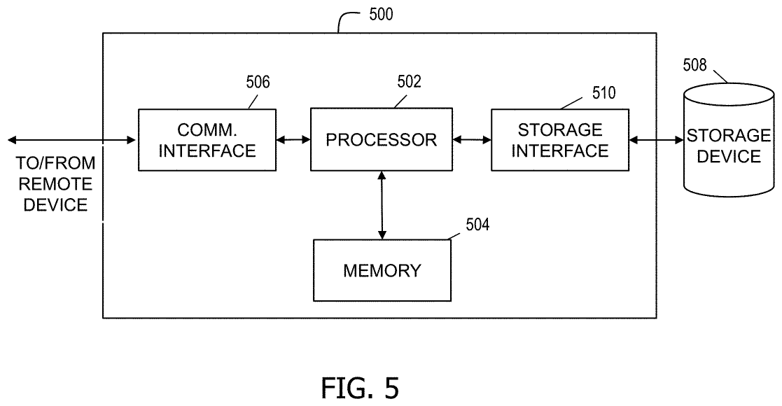

In one embodiment, entity computer device 400 further includes a communication interface 425, communicatively coupled to a remote device such as a server computing device 500 (shown in FIG. 5). Communication interface 425 may include, for example, a wired or wireless network adapter or a wireless data transceiver for use with a mobile telecommunications network.

In the example embodiment, memory 410 stores computer readable instructions for providing a user interface to entity 401 through media output component 415 and, optionally, for receiving and processing input from input device 420. A user interface may include, among other possibilities, a web browser or a client application. Web browsers enable users, such as entity 401, to display and interact with media and other information typically embedded on a web page or a website from server computing device 500. A client application allows entity 401 to interact with, for example, server computing device 500. For example, instructions may be stored by a cloud service, and the output of the execution of the instructions sent to the media output component 415. Processor 405 executes computer-executable instructions for implementing aspects of the disclosure. In some embodiments, the processor 405 is transformed into a special purpose microprocessor by executing computer-executable instructions or by otherwise being programmed.

FIG. 5 illustrates an example configuration of a server computing device 500 that may be used to implement currency tracking computing device 106 (shown in FIG. 1). Computing device 500 includes a processor 502 for executing instructions. Instructions may be stored to a memory 504. Processor 502 may include one or more processing units (e.g., in a multi-core configuration) for executing instructions. The instructions may be executed within a variety of different operating systems on data optimizing computing device, such as UNIX, LINUX, Microsoft Windows®, etc. It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc.).

Processor 502 is operatively coupled to a communication interface 506 such that computing device 500 is capable of communication with remote devices. Processor 502 may also be operatively coupled to a storage device 508. For example, storage device 508 is used to implement currency tracking database 108 (shown in FIG. 1). Storage device 508 is any computer-operated hardware suitable for storing and/or retrieving data. In some embodiments, storage device 508 is integrated in computing device 500. For example, computing device 500 may include one or more hard disk drives as storage device 508. In other embodiments, storage device 508 is external to computing device 500. For example, storage device 508 may include multiple storage units such as hard disks or solid state disks in a redundant array of inexpensive disks (RAID) configuration. Storage device 508 may include a storage area network (SAN) and/or a network attached storage (NAS) system.

In some embodiments, processor 502 is operatively coupled to storage device 508 via a storage interface 510. Storage interface 510 is any component capable of providing processor 502 with access to storage device 508. Storage interface 510 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 502 with access to storage device 508.

Memory 504 may include, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

As will be appreciated based on the foregoing specification, the above-described embodiments of the disclosure may be implemented using computer programming or engineering techniques including computer software, firmware, hardware or any combination or subset thereof, wherein the technical effect or enabling individual chargeback tracking, settlement, and recording. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps”, or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A computing device for tracking physical currency, the computing device comprising a processor communicatively coupled to a memory, the processor configured to:
communicate with an application executable on a plurality of entity computing devices associated with a plurality of entities;
store a plurality of currency identifiers in the memory, the plurality of currency identifiers associated with a respective plurality of physical currency units, wherein each currency identifier uniquely identifies the respective physical currency unit;
store a plurality of entity identifiers in the memory, the plurality of entity identifiers associated with a respective plurality of individual currency accounts associated with the plurality of entities, wherein each entity identifier uniquely identifies the respective entity and the respective individual currency account;
receive, from the application executing on an initiating entity computing device of the plurality of entity computing devices, a first transfer initiation message including a first currency identifier of the plurality of currency identifiers and a first entity identifier and a second entity identifier of the plurality of entity identifiers, the first transfer initiation message indicating that a first entity of the plurality of entities, as identified by the first entity identifier, intends to transfer at least a portion of a value of a first physical currency unit, as identified by the first currency identifier, to a second entity of the plurality of entities, as identified by the second entity identifier;
in response to the first transfer initiation message, verify that the first transfer initiation message is legitimate by performing a lookup for a first record in a tracking database, wherein the first record indicates that the first entity is registered as an owner of the first physical currency unit; and
in response to the verification, store a second record in the tracking database, wherein the second record includes the second entity identifier of the second entity and, registers the second entity as the registered owner of the at least portion of the value of the first physical currency unit associated with the first currency identifier, and indicates that the second entity received the at least portion of the value from the first entity; and
add the at least a portion of the value of the first physical currency unit to a second individual currency account of the plurality of individual currency accounts, wherein the second individual currency account is associated with the second entity identifier, and wherein the application executing on a second entity computing device of the plurality of entity computing devices enables the second entity to access contents of the second individual currency account.

2. The computing device of claim 1, wherein the first physical currency unit is a paper currency bill having an associated value.

3. The computing device of claim 1, wherein the at least portion of the value of the first physical currency unit is less than a full value of the first physical currency unit, and wherein the processor is further configured to:
store, in the second record, a first new currency identifier associated with the portion of the value transferred;
store a third record in the tracking database, wherein the third record includes a second new currency identifier associated with a portion of the value not transferred and registers the first entity as an owner of the second new currency identifier; and
associate, in the tracking database, the second and third records with a transfer history of the first physical currency unit.

4. The computing device of claim 1, wherein each entity identifier is associated with one of an individual person, a financial institution, and a merchant.

5. The computing device of claim 1, wherein the application is a digital wallet associated with the respective individual currency account of the corresponding entity.

6. The computing device of claim 1, wherein the processor is further configured to store a transfer history for each currency identifier of the plurality of currency identifiers, wherein each transfer history includes a plurality of currency records including the same currency identifier.

7. The computing device of claim 1, wherein the processor is further configured to:
receive a currency consignment message associated with the first physical currency unit, the currency consignment message including the first currency identifier and indicating the first physical currency unit has been consigned to an approved entity; and
store a consignment record in the tracking database, the consignment record including the first currency identifier and a consignment flag.

8. A computer-implemented method for tracking physical currency, the method implemented using a computing device including a processor in communication with at least one memory device for storing data, said method comprising:
communicate with an application executable on a plurality of entity computing devices associated with a plurality of entities;
storing a plurality of currency identifiers in the memory, the plurality of currency identifiers associated with a respective plurality of physical currency units, wherein each currency identifier uniquely identifies the respective physical currency unit;
storing a plurality of entity identifiers in the memory, the plurality of entity identifiers associated with a respective plurality of individual currency accounts associated with the plurality of entities, wherein each entity identifier uniquely identifies the respective entity and the respective individual currency account;
receiving, from the application executing on an initiating entity computing device of the plurality of entity computing devices, a first transfer initiation message including a first currency identifier of the plurality of currency identifiers and a first entity identifier and a second entity identifier of the plurality of entity identifiers, the first transfer initiation message indicating that a first entity of the plurality of entities, as identified by the first entity identifier, intends to transfer at least a portion of a value of a first physical currency unit, as identified by the first currency identifier, to a second entity of the plurality of entities, as identified by the second entity identifier;
in response to the first transfer initiation message, verifying that the first transfer initiation message is legitimate by performing a lookup for a first record in a tracking database, wherein the first record indicates that the first entity is registered as an owner of the first physical currency unit; and
in response to the verification, storing a second record in the tracking database, wherein the second record includes a second entity identifier of the second entity, registers the second entity as the registered owner of the at least portion of the value of the first physical currency unit associated with the first currency identifier, and indicates that the second entity received the at least portion of the value from the first entity; and
adding the at least portion of the value of the first physical currency unit to a second individual currency account of the plurality of individual currency accounts, wherein the second individual currency account is associated with the second entity identifier, and wherein the application executing on a second entity computing device of the plurality of entity computing devices enables the second entity to access contents of the second individual currency account.

9. The computer-implemented method of claim 8, wherein the at least portion of the value of the first physical currency unit is a paper currency bill having an associated value.

10. The computer-implemented method of claim 8, wherein the first physical currency unit is less than a full value of the first physical currency unit, and wherein said method further comprises:
storing, in the second record, a first new currency identifier associated with the portion of the value transferred;
storing a third record in the tracking database, wherein the third record includes a second new currency identifier associated with a portion of the value not transferred and registers the first entity as an owner of the second new currency identifier; and
associating, in the tracking database, the second and third records with a transfer history of the first physical currency unit.

11. The computer-implemented method of claim 8, wherein each entity identifier is associated with one of an individual person, a financial institution, and a merchant.

12. The computer-implemented method of claim 8, wherein the application is a digital wallet associated with the respective individual currency account of the corresponding entity.

13. The computer-implemented method of claim 8, further comprising storing a transfer history for each currency identifier of the plurality of currency identifiers, wherein each transfer history includes a plurality of currency records including the same currency identifier.

14. The computer-implemented method of claim 8, further comprising:
receiving a currency consignment message associated with the first physical currency unit, the currency consignment message including the first currency identifier and indicating the first physical currency unit has been consigned to an approved entity; and
storing a consignment record in the tracking database, the consignment record including the first currency identifier and a consignment flag.

15. A non-transitory computer-readable storage medium that includes computer-executable instructions for tracking physical currency, wherein when executed by a computing device comprising a processor in communication with at least one memory device, the computer-executable instructions cause the processor to:
communicate with an application executable on a plurality of entity computing devices associated with a plurality of entities;
store a plurality of currency identifiers in the memory, the plurality of currency identifiers associated with a respective plurality of physical currency units, wherein each currency identifier uniquely identifies the respective physical currency unit;
store a plurality of entity identifiers in the memory, the plurality of entity identifiers associated with a respective plurality of individual currency accounts associated with the plurality of entities, wherein each entity identifier uniquely identifies the respective entity and the respective individual currency account;
receive, from the application executing on an initiating entity computing device of the plurality of entity computing devices, a first transfer initiation message including a first currency identifier of the plurality of currency identifiers and a first entity identifier and a second entity identifier of the plurality of entity identifiers, the first transfer initiation message indicating that a first entity of the plurality of entities, as identified by the first entity identifier, intends to transfer at least a portion of a value of a first physical currency unit, as identified by the first currency identifier, to a second entity of the plurality of entities, as identified by the second entity identifier;
in response to the first transfer initiation message, verify that the first transfer initiation message is legitimate by performing a lookup for a first record in a tracking database, wherein the first record indicates that the first entity is registered as an owner of the first physical currency unit; and
in response to the verification, store a second record in the tracking database, wherein the second record includes the second entity identifier of the second entity, registers the second entity as the registered owner of the at least portion of the value of the first physical currency unit associated with the first currency identifier, and indicates that the second entity received the at least portion of the value from the first entity; and
add the at least portion of the value of the first physical currency unit to a second individual currency account of the plurality of individual currency accounts, wherein the second individual currency account is associated with the second entity identifier, and wherein the application executing on a second entity computing device of the plurality of entity computing devices enables the second entity to access contents of the second individual currency account.

16. The non-transitory computer readable medium of claim 15, wherein the first physical currency unit is a paper currency bill having an associated value.

17. The non-transitory computer readable medium of claim 15, wherein the at least portion of the value of the first physical currency unit is less than a full value of the first physical currency unit, and wherein the computer-executable instructions further cause the processor to:
store, in the second record, a first new currency identifier associated with the portion of the value transferred;
store a third record in the tracking database, wherein the third record includes a second new currency identifier associated with a portion of the value not transferred and registers the first entity as an owner of the second new currency identifier; and
associate, in the tracking database, the second and third records with a transfer history of the first physical currency unit.

18. The non-transitory computer readable medium of claim 15, wherein each entity identifier is associated with one of an individual person, a financial institution, and a merchant.

19. The non-transitory computer readable medium of claim 15, wherein the application is a digital wallet associated with the respective individual currency account of the corresponding entity.

20. The non-transitory computer readable medium of claim 15, wherein the computer-executable instructions further cause the processor to store a transfer history for each currency identifier of the plurality of currency identifiers, wherein each transfer history includes a plurality of currency records including the same currency identifier.
